(19) United States
(12) Patent Application Publication
(10) Pub. No.: US 2014/0279645 A1
(43) Pub. Date: Sep. 18, 2014

(54) BENFICIARY CROWDSOURCING

(71) Applicant: RocketHub Inc., New York, NY (US)

(72) Inventors: Jedidiah S. Cohen, New York, NY (US); Brian Meece, New York, NY (US); Vladimir Vukicevic, Roslyn Heights, NY (US); Alon Hillel-Tuch, Brooklyn, NY (US)

(21) Appl. No.: 13/832,102

(22) Filed: Mar. 15, 2013

(51) Int. Cl. G06Q 30/02

(52) U.S. Cl. CPC G06Q 30/0279
USPC 705/329

(57) ABSTRACT

A platform can receive information about a product including a product cost. The platform can also receive a registration message that can designate the product and at least one beneficiary. The platform can provide a description of a campaign associated with the product and the beneficiary to at least one funder. One or more funders can fund the campaign. The funding amount for the campaign can be stored by the platform. The platform can determine that the campaign meets or exceeds at least one campaign threshold. Examples of campaign thresholds can include a time limit, a minimum funding amount, a maximum funding amount a minimum number of funders and a maximum number of funders. Based on the determining that the campaign meets or exceeds the at least one campaign threshold, the platform can cause the ownership of the product to be transferred to the beneficiary.

### BACKGROUND

Crowdfunding sites provide mechanisms for fundraisers to solicit funding from the general public and/or other sources to fund the achievement of an objective. The crowdfunding site can provide information about such a campaign to potential sources of funding (“funders”). A funder can view information about the campaign on the crowdfunding site and decide to make a contribution (or investment) to fund the enterprise. Information about a campaign can include background information about the fundraisers, the objectives of the campaign, funding goals, consideration by the enterprise for funders, etc. For example, a fundraiser can be a musical group mounting a campaign to fund going on tour. The information about such a campaign can include information about members of the band, the prospective tour schedule, samples of music by the band, a video pitch for funding by members of the band, etc. The band may offer a discount on concert tickets to funders as consideration for funding its campaign to mount the tour.

### SUMMARY

In accordance with various implementations, a crowdfunding platform can receive information about a product including a product cost. For example, the product can be offered for sale by a vendor at a given price. The platform can receive a registration message designating the product and at least one beneficiary. The platform can provide a description of a campaign associated with the product and the beneficiary to at least one funder. The campaign can be associated with a beneficiary and at least one product associated with a product cost. Funders can contribute consideration (funding) to the campaign. The funding amount for the campaign can be stored by the platform. The platform can determine that the campaign meets or exceeds at least one campaign threshold. Examples of campaign thresholds include a time limit, a minimum funding amount, a maximum funding amount a minimum number of funders and a maximum number of funders. Based on the determining that the campaign meets or exceeds the at least one campaign threshold, the platform can cause the ownership of the product to be transferred to the beneficiary. For example, the platform can arrange to purchase the product from a product vendor and provide the purchased product to the beneficiary. Likewise, the platform can cause a third party to purchase the product for the beneficiary, for example by providing funds contributed to the campaign by funders to the third party purchaser.

### BRIEF DESCRIPTION OF THE DRAWINGS

FIG. 1 shows a system in accordance with an implementation of the disclosed subject matter.

FIG. 2 shows a method in according to an implementation of the disclosed subject matter.

FIG. 3 shows a network configuration according to an implementation of the disclosed subject matter.

FIG. 4 shows a system in accordance with an implementation of the disclosed subject matter.

### DETAILED DESCRIPTION

In accordance with embodiments of the disclosed subject matter, a party can register with platform to crowdfund the purchase of a product for a beneficiary. The registrant can be the beneficiary or a third party. The platform can provide information to funders about a campaign to purchase the product for the beneficiary. For example, a father can register at the platform and list his son as the beneficiary for the purchase of a new car. The platform can provide information about a campaign to purchase the car for the son to actual and prospective funders, who may then fund the campaign. When the platform determines that one or more campaign thresholds are met, the product can be purchased for the beneficiary.

The purpose of the campaign can be to purchase a product, which can be a good, a service, a license (e.g., for software), a right (e.g., a down payment on a house), an obligation (e.g., pay off a loan) or anything else that can confer a benefit on the beneficiary. The term “purchase” can include any transfer of consideration for a product and can involve the transfer of actual currency, virtual currency, a trade such as a barter, a release from an obligation, a donation of a right, etc. The product can have a cost that can be expressed as anything of value, including the types of consideration mentioned above.

The platform can store a funding amount from at least one funder of the campaign, e.g., in a database. The account itself can be maintained by the platform. That is, the platform can accept payments from funders and deposit them into a campaign account. Likewise, the campaign account can be maintained by another entity and the platform can keep track of the amounts provided by each funder and/or the total amount provided by funders in the campaign account. For example, the platform can track funding amounts, and may also maintain a campaign account to store funds, from funders such as relatives of the college graduate who donate funds to the campaign to purchase the new car.

The platform can determine that the campaign meets or exceeds at least one campaign threshold. Examples of a campaign threshold can include a time limit, a minimum funding amount, a maximum funding amount, a minimum number of funders, a maximum number of funders, etc., or a combination thereof. For example, a time limit of 30 days can be set for the campaign, after which it is to be closed. That is, funders can donate money to the campaign from the time of its inception until 30 days after inception, after which the campaign can be closed to new donations. In an implementation, the campaign can be re-opened after it has been closed, or may extend the time limit while the campaign is underway. Likewise, the campaign may require a minimum or maximum number of funders, or may specify qualifications that a funder must meet to donate to the campaign. For example, the platform or a registrant such as a father may specify that only relatives (e.g., from a pre-approved list) of the beneficiary (e.g., a daughter) may donate to the campaign. Alternatively, the registrant or platform may specify particular qualifications (e.g., asset level, income level, participation in other campaigns (past, present or future), age, etc.) that a funder must meet to donate to the campaign. The funder qualifications can be included in a funder profile that can be stored by the platform. When a funder seeks to donate to a campaign, the platform can compare the funder qualifications with the campaign funder requirements and, if there is a match, accept funding from the funder. If there is not a match, the platform can prevent the funder from donating to (funding) the campaign. The campaign thresholds can also be imposed by the platform.

When the platform determines that one or more campaign thresholds have been met, the platform can cause the ownership of the product to be transferred to the beneficiary. For example, the platform can cause the product to be purchased for the beneficiary, either by a third party or the platform can purchase the product itself and transfer ownership to the beneficiary. As used herein, the term “purchase” includes obtaining the right to confer at least a part of the benefit of the product by transferring consideration of any kind to the product provider. The phrase “transfer ownership to the beneficiary” includes conferring at least a part of the benefit obtained by purchasing the product to the beneficiary. Transferring ownership of the product to the beneficiary can include, for example, transferring ownership or rental of a good, providing a service, providing a license right (e.g., for software), providing a down payment on a house, discharging an obligation (e.g., paying off all or part of a student loan, etc.)

In various implementations, the product can be provided by a vendor. For example, the registrant can be a student and the product can be a new car provided by an automobile manufacturer or a sales outlet. In an implementation, a campaign can be mounted by the automobile manufacturer itself on behalf of college graduates who have graduated within the past six months or one year.

In some situations, the total amount of funding donated to a campaign may exceed a campaign threshold, such as a minimum funding amount. For example, the product (such as a new car) may cost $21,000 and the campaign may in fact raise $27,500. This may occur by the time the campaign time limit has expired. The platform can determine the difference between the amount of funding in the campaign and the cost of transferring ownership of the product to the beneficiary. This difference can be the remainder amount. The remainder amount can be disposed in any suitable way, including as actual currency, virtual currency, a credit, an upgrade to the product obtained for the beneficiary, etc. For example, part or all of the remainder amount can be disposed as a check or actual currency (e.g., dollar) deposit to a bank account, as virtual currency units to an online account, a credit at a store or service provider, as a stored value card, as an upgrade to the product, such as a “power package” or “sports package” to an automobile. All or part of the remainder can be provided to the beneficiary, to the platform, to one or more funders or to a third party, or any combination thereof. In various implementations, the registrant can send a message to the platform with instructions on how at least a part of the remainder is to be disbursed. For example, if the registrant is the beneficiary, then the beneficiary may send such a message, e.g., by selecting an upgrade or a more expensive product to be obtained for the beneficiary. Likewise, a funder can send such a message to the platform, electing to receive all or a portion of the amount the funder donated, or else to provide an amount to the beneficiary or a third party, such as a charity.

An actual currency can be a medium of exchange issued by or on behalf of a sovereign government. Examples of actual currency include dollars, euros, Swiss francs, kroner, etc. Virtual currency can include a medium of exchange issued by or on behalf of an entity other than a sovereign government. Examples of virtual currency include in-game currency such as Station Cash in Everquest II published by Sony Online Entertainment, virtual world currency such as Linden Dollars used in Second Life by Linden Lab, Facebook Credits, electronic cash such as Bitcoin, etc.

In some implementations, the platform may also determine that the campaign does not meet or exceed at least one campaign threshold. For example, when the campaign time limit expires, the campaign may not have raised enough funding to purchase the product for the beneficiary. In such a situation, at least a part of the amount of funding raised may be provided to the beneficiary, to the platform, to one or more funders or to a third party, such as another beneficiary such as a relative of the beneficiary or a charity. As for the remainder, the amount raised can be disposed in any suitable way, including as actual currency, virtual currency, a credit, an upgrade to the product obtained for the beneficiary, etc. For example, part or all of the remainder amount can be disposed as a check or actual currency (e.g., dollar) deposit to a bank account, as virtual currency units to an online account, a credit at a store or service provider, as a stored value card, as a less expensive product or version of the product.

FIG. 1 shows an implementation of the disclosed subject matter. A platform 101 can receive from a registrant 103 or a vendor (not shown) information about a product 105 that can include a product cost. The platform 101 can receive from the registrant 103 a registration message that can designate the product 105 and at least one beneficiary 106. Funder 102 can provide funding to the campaign, such as money, pledged goods or services or anything else of value. The funding provided by the funder 102 can be sent to or through the platform 101 and a campaign amount can be stored in a campaign account database 104. The platform 101 can determine that the campaign has met at least one campaign threshold and cause ownership of the product 105 to be transferred to the beneficiary 106.

FIG. 2 shows an implementation of the method of the disclosed subject matter. A platform can receive information about a product that can include a product cost. The platform can receive a registration message that can designate the product and at least one beneficiary. The platform can establish a campaign to fund the purchase of the product for the beneficiary. Campaign information (such as a description of the campaign) can be sent to a funder. The funder can provide funding to the campaign, the amount of which can be stored in a campaign database. The platform can determine that at least one campaign threshold has been met and cause the ownership of the product to be transferred to the beneficiary.

Implementations of the presently disclosed subject matter may be implemented in and used with a variety of component and network architectures. FIG. 3 is an example computer 20 suitable for implementing the presently disclosed subject matter. The computer 20 includes one or more of a bus 21 which interconnects major components of the computer 20, a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like. The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) that controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an Internet Service Provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 4.

Many other devices or components (not shown) may be connected in a similar manner (e.g., document scanners, digital cameras and so on). Conversely, all of the components shown in this Figure need not be present to practice the present disclosure. The components can be interconnected in different ways from that shown. The operation of a computer such as that shown in this Figure is readily known in the art and is not discussed in detail in this application. Code to implement the present disclosure can be stored in computer-readable storage media such as one or more of the memory 27, fixed storage 23, removable media 25, or on a remote storage location.

FIG. 4 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description for purpose of explanation, have been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

What is claimed is:

1. A method, comprising:
receiving information about a product including a product cost;
receiving a registration message designating the product and at least one beneficiary;
providing a description of a campaign associated with the product and the beneficiary to at least one funder;
storing a funding amount from the at least one funder of the campaign;
determining that the campaign meets or exceeds at least one campaign threshold selected from the group consisting of a time limit, the product cost, a minimum funding amount, a maximum funding amount a minimum number of funders and a maximum number of funders; and
based on the determining that the campaign meets or exceeds the at least one campaign threshold, causing the ownership of the product to be transferred to the beneficiary.

2. The method of claim 1, wherein the product is at least one from the group consisting of a good, a service, a license, a credit and an obligation.

3. The method of claim 1, wherein the campaign threshold includes a time limit and a minimum funding amount and further comprising:
determining that the time limit for the campaign has expired;
determining that the amount of funding is greater than or equal to the minimum funding amount; and
wherein causing the ownership of the product to be transferred to the beneficiary comprises purchasing the product from a vendor for the beneficiary using funds associated with the campaign.

4. The method of claim 1, wherein the causing the ownership of the product to be transferred to the beneficiary comprises providing at least some of the funds associated with the campaign to the beneficiary.

5. The method of claim 4, wherein the product has a product cost and further comprising:
determining a remainder amount based at least partly on the difference between the stored funding amount and the product cost; and
providing at least part of the remainder amount to the beneficiary in the form of at least one from the group consisting of actual currency, virtual currency, a credit and an upgrade.

6. The method of claim 4, wherein the product has a product cost and further comprising:
determining a remainder amount based at least partly on the difference between the stored funding amount and the product cost; and
providing at least a part of the remainder amount to at least one of the funders.

7. The method of claim 5, further comprising:
determining a remainder amount based at least partly on the difference between the stored funding amount and the product cost; and
providing at least a part of the remainder amount to the beneficiary.

8. A method, comprising:
receiving information about a product including a product cost;
receiving a registration message designating the product and at least one beneficiary;
providing a description of a campaign associated with the product and the beneficiary to at least one funder;
storing a funding amount from at least one funder of the campaign;
determining that the campaign does not meet or exceed at least one campaign threshold selected from the group consisting of a time limit, a minimum funding amount, a maximum funding amount a minimum number of funders and a maximum number of funders;
providing at least a part of the funding amount to at least one selected from the group consisting of a beneficiary and a funder.

9. The method of claim 8, wherein the at least a part of the funding amount is provided in the form of at least one selected from the group consisting of actual currency, virtual currency, and a credit.

10. A system, comprising:
a memory storing a software application;
a database;
a processor in communication with the memory and the database, the processor adapted to:
receive information about a product including a product cost;
receive a registration message designating the product and at least one beneficiary;
provide a description of a campaign associated with the product and the beneficiary to at least one funder;
store a funding amount from at least one funder of the campaign;
determine that the campaign meets or exceeds at least one campaign threshold selected from the group consisting of a time limit, a minimum funding amount, a maximum funding amount a minimum number of funders and a maximum number of funders; and
based on the determination that the campaign meets or exceeds the at least one campaign threshold, cause the ownership of the product to be transferred to the beneficiary.

11. The system of claim 11, wherein the database is adapted to store at least one selected from the group consisting of a time limit, a minimum funding amount, a maximum funding amount a minimum number of funders and a maximum number of funders.

12. The system of claim 12, the processor further adapted to:
determine that the time limit for the campaign has expired;
determine that the amount of funding is greater than or equal to the minimum funding amount; and
determine a remainder amount based at least partly on the difference between the stored funding amount and the product cost; and
provide at least a part of the remainder amount to the beneficiary in the form of at least one from the group consisting of actual currency, virtual currency, a credit and an upgrade.

13. A system comprising:
a memory;
a processor connected to the memory, the processor configured to:
receive information about a product including a product cost;
receive a registration message designating the product and at least one beneficiary;
provide a description of a campaign associated with the product and the beneficiary to at least one funder;
store a funding amount from at least one funder of the campaign;
determine that the campaign meets or exceeds at least one campaign threshold selected from the group consisting of a time limit, a minimum funding amount, a maximum funding amount a minimum number of funders and a maximum number of funders; and
based on the determination that the campaign meets or exceeds the at least one campaign threshold, cause the ownership of the product to be transferred to the beneficiary.

14. The system of claim 14, the processor further configured to:
determine that the time limit for the campaign has expired;
determine that the amount of funding is greater than or equal to the minimum funding amount; and
permit the product to be purchased from a vendor for the beneficiary using funds associated with the campaign.

15. The system of claim 14, the processor further configure to:
determine a remainder amount based at least partly on the difference between the stored funding amount and the product cost; and
provide at least a part of the remainder amount to the beneficiary in the form of at least one from the group consisting of actual currency, virtual currency, a credit and an upgrade.

16. The system of claim 14, the processor further configured to:
determine a remainder amount based at least partly on the difference between the stored funding amount and the product cost; and
provide at least a part of the remainder amount to at least one of the funders.

17. A system comprising:
a memory;
a processor connected to the memory, the processor configured to:
receiving information about a product including a product cost;
receive a registration message designating the product and at least one beneficiary;
provide a description of a campaign associated with the product and the beneficiary to at least one funder;
store a funding amount from at least one funder of the campaign;
determine that the campaign does not meet or exceed at least one campaign threshold selected from the group consisting of a time limit, a minimum funding amount, a maximum funding amount a minimum number of funders and a maximum number of funders;
provide at least a part of the funding amount to at least one selected from the group consisting of a beneficiary, a funder and a fundraiser.
